(19) United States
(12) Patent Application Publication
(10) Pub. No.: US 2026/0109314 A1
(43) Pub. Date: Apr. 23, 2026

(54) COWL TOP PANEL AND VEHICLE

(71) Applicant: SUBARU CORPORATION, Tokyo (JP)

(72) Inventor: Kazushige ISHIBASHI, Tokyo (JP)

(21) Appl. No.: 19/355,793

(22) Filed: Oct. 10, 2025

(30) Foreign Application Priority Data
Oct. 22, 2024 (JP) 2024-186025

(51) Int. Cl. B60R 21/36; B62D 25/08; B60S 1/04

(52) U.S. Cl. CPC B60R 21/36; B62D 25/081; B60S 1/0452

(57) ABSTRACT

A cowl top panel for a vehicle includes a panel and a rib. The rib is provided on a first surface of the panel. The first surface of the panel is on a side where a windshield is provided. The rib protrudes from the first surface in a region different from a region opposed to the windshield and extends in a width direction of the vehicle. The rib includes a distal end extending beyond a rear surface of the windshield in a normal direction of the windshield. The rib has a notch and is configured to, when an airbag is deployed from an airbag device provided between the panel and a front hood to an outside of the vehicle and the panel moves toward the windshield, break at a position where the notch is provided by coming into contact with a lower end part of the windshield.

### CROSS-REFERENCE TO RELATED APPLICATIONS

The present application claims priority from Japanese Patent Application No. 2024-186025 filed on October 22, 2024, the entire contents of which are hereby incorporated by reference.

### BACKGROUND

The disclosure relates to a cowl top panel provided in a vehicle, and to a vehicle including such a cowl top panel.

In a vehicle such as an automobile, a cowl top panel is provided between a front hood and a windshield that are at a front part of the vehicle. For example, Japanese Unexamined Patent Application Publication No. 2005-238915 discloses a technique for a cowl top panel intended to reduce an impact upon receiving an external force.

### SUMMARY

An aspect of the disclosure provides a cowl top panel configured to be applied to a vehicle. The cowl top panel includes a panel and a rib. The panel is provided between a front hood and a windshield that are at a front part of the vehicle. The panel extends in a width direction of the vehicle and is configured to cover a lower end part of the windshield. The rib is provided on a first surface of the panel. The first surface of the panel is a surface on a side where the windshield is provided. The rib is provided in a region of the first surface different from a region opposed to the windshield. The rib protrudes from the first surface of the panel and extends in the width direction of the vehicle. The rib includes a distal end extending beyond a rear surface of the windshield in a normal direction of the windshield. The rib has a notch and is configured to, when an airbag is deployed from an airbag device provided between the panel and the front hood to an outside of the vehicle and the panel moves toward the windshield, break at a position where the notch is provided by coming into contact with the lower end part of the windshield.

An aspect of the disclosure provides a vehicle including a front hood, a windshield, a cowl top panel, and an airbag device. The front hood is provided at a front part of the vehicle. The windshield is provided at the front part of the vehicle. The cowl top panel is provided between the windshield and the front hood. The airbag device is provided between the cowl top panel and the front hood and is configured to deploy an airbag to an outside of the vehicle. The cowl top panel includes a panel and a rib. The panel extends in a width direction of the vehicle and is configured to cover a lower end part of the windshield. The rib is provided on a first surface of the panel. The first surface of the panel is a surface on a side where the windshield is provided. The rib is provided in a region of the first surface different from a region opposed to the windshield. The rib protrudes from the first surface of the panel and extends in the width direction of the vehicle. The rib includes a distal end extending beyond a rear surface of the windshield in a normal direction of the windshield. The rib has a notch and is configured to, when the airbag is deployed from the airbag device and the panel moves toward the windshield, break at a position where the notch is provided by coming into contact with the lower end part of the windshield.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is an explanatory diagram illustrating an example of a vehicle provided with a cowl top panel according to one example embodiment of the disclosure.

FIG. 2A is an explanatory diagram illustrating the cowl top panel illustrated in FIG. 1 and its periphery.

FIG. 2B is another explanatory diagram illustrating the cowl top panel illustrated in FIG. 1 and its periphery.

FIG. 3 is a sectional diagram illustrating the cowl top panel illustrated in FIG. 1 and its periphery.

FIG. 4 is a sectional diagram illustrating a configuration example of a rib of the cowl top panel illustrated in FIG. 3.

FIG. 5 is an explanatory diagram illustrating an example of a movable range of a wiper arm.

FIG. 6 is an explanatory diagram illustrating an operation example of the cowl top panel when an airbag is deployed.

FIG. 7 is an explanatory diagram illustrating an operation example of a cowl top panel according to a reference example.

FIG. 8 is a sectional diagram illustrating a configuration example of a rib according to a modification example.

FIG. 9 is a sectional diagram illustrating a configuration example of a rib according to another modification example.

FIG. 10 is a sectional diagram illustrating a configuration example of a rib according to another modification example.

### DETAILED DESCRIPTION

Some vehicles are provided with an airbag device that deploys an airbag to an outside of the vehicle in order to protect a pedestrian. In this case, a force of the deployed airbag may be applied to a windshield via a cowl top panel, which may possibly damage the windshield. What is desired is to prevent the windshield from being damaged when the airbag is deployed.

It is desirable to provide a cowl top panel and a vehicle that each make it possible to prevent a windshield from being damaged when an airbag is deployed.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### <Example Embodiment>

### <Configuration Example>

FIG. 1 illustrates a configuration example of a vehicle 1 including a cowl top panel according to an example embodiment. For example, the cowl top panel may be a cowl top panel 11 to be described later. The vehicle 1 includes a front hood 2, a windshield 3, and a cowl top panel 10.

The front hood 2 is a cover provided at a front part of the vehicle 1. For example, when the vehicle 1 is an engine vehicle, the front hood 2 may be a cover of an engine room.

The windshield 3, also known as a front glass, is provided at a front part of a cabin of the vehicle 1. A driver may drive the vehicle 1 while checking ahead of the vehicle 1 through the windshield 3.

The cowl top panel 10 is a cover provided between the front hood 2 and the windshield 3 in a longitudinal direction (a horizontal direction in FIG. 1) of the vehicle 1.

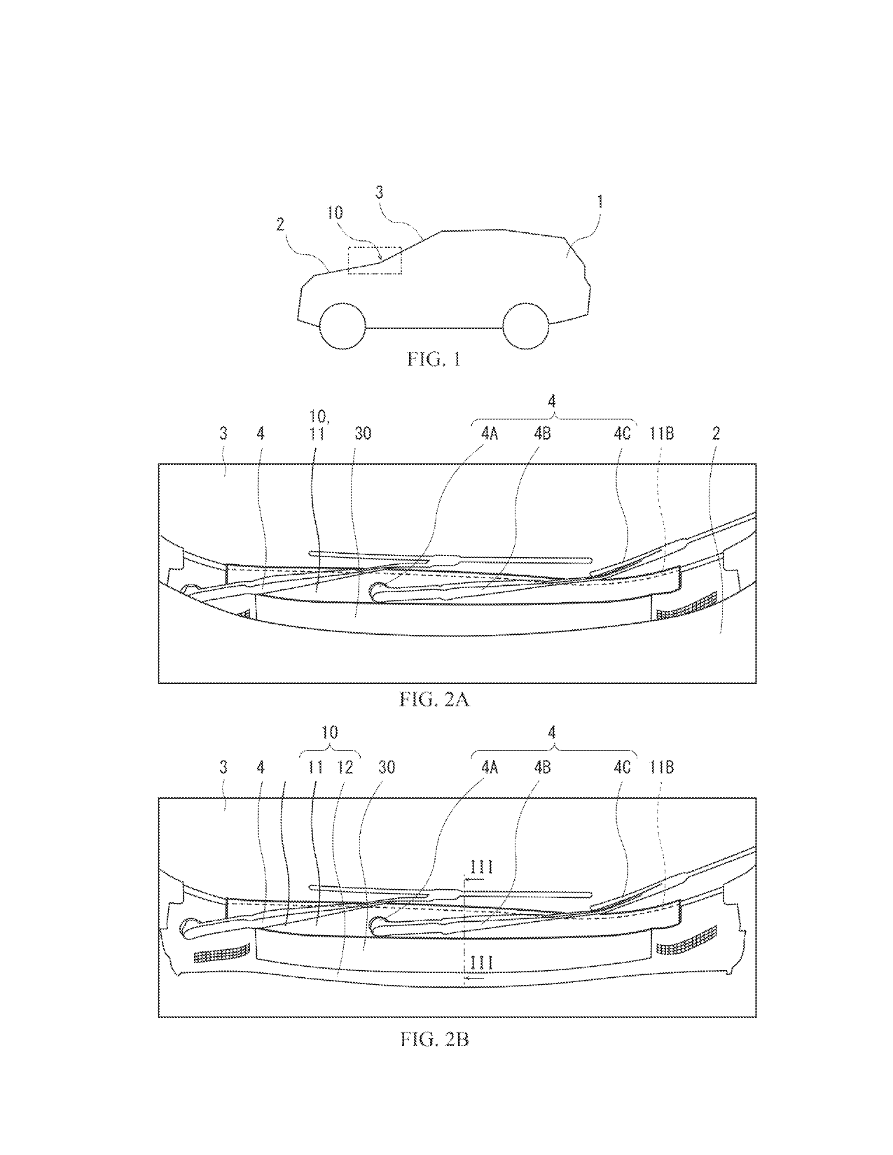

FIGS. 2A and 2B illustrate the cowl top panel 10 and the periphery of the cowl top panel 10. FIGS. 2A and 2B illustrate a part surrounded by a dashed-dotted line in FIG. 1 as viewed from above the vehicle 1. FIG. 2A illustrates a normal state in which the front hood 2 is present. In FIG. 2B, the front hood 2 is removed for convenience of description. The vehicle 1 may include a wiper device 4. The vehicle 1 includes an airbag device 30.

The cowl top panel 10 may include two cowl top panels 11 and 12. The cowl top panel 11 may be a resin member extending in a width direction of the vehicle 1 and provided adjacent to an end part of the windshield 3. In FIGS. 2A and 2B, the cowl top panel 11 is illustrated with a thick line. The cowl top panel 12 may be a resin member extending in the width direction of the vehicle 1. The cowl top panel 12 may be provided in front of the cowl top panel 11 in the vehicle 1 and extend to the left and right sides of the cowl top panel 11. As illustrated in FIG. 2A, part of the cowl top panel 12 may be covered with the front hood 2.

The wiper device 4 may be configured to wipe a front surface of the windshield 3 to ensure a field of view of the driver when, for example, it is raining. As illustrated in FIGS. 2A and 2B, the vehicle 1 may include two wiper devices 4. Each of the wiper devices 4 may include a shaft unit 4A, a wiper arm 4B, and a wiper blade 4C. Each shaft unit 4A may be configured to rotate the corresponding wiper device 4 in a predetermined angular range. Each wiper arm 4B may be configured to support the corresponding wiper blade 4C. One end of the wiper arm 4B may be coupled to the corresponding shaft unit 4A. The other end of the wiper arm 4B may be coupled to the corresponding wiper blade 4C. The wiper blade 4C may be disposed to be in contact with the front surface of the windshield 3 and may be configured to wipe the front surface of the windshield 3. With this configuration, it is possible for each of the wiper devices 4 to wipe the front surface of the windshield 3 by rotating about the corresponding shaft unit 4A.

The airbag device 30 may be configured to deploy an airbag 31 (see FIG. 6) to an outside of the vehicle 1 in order to protect a pedestrian if the vehicle 1 comes into contact with the pedestrian. As illustrated in FIG. 2B, the airbag device 30 may be provided between the cowl top panel 11 and the cowl top panel 12 in the longitudinal direction (a vertical direction in FIGS. 2A and 2B) of the vehicle 1.

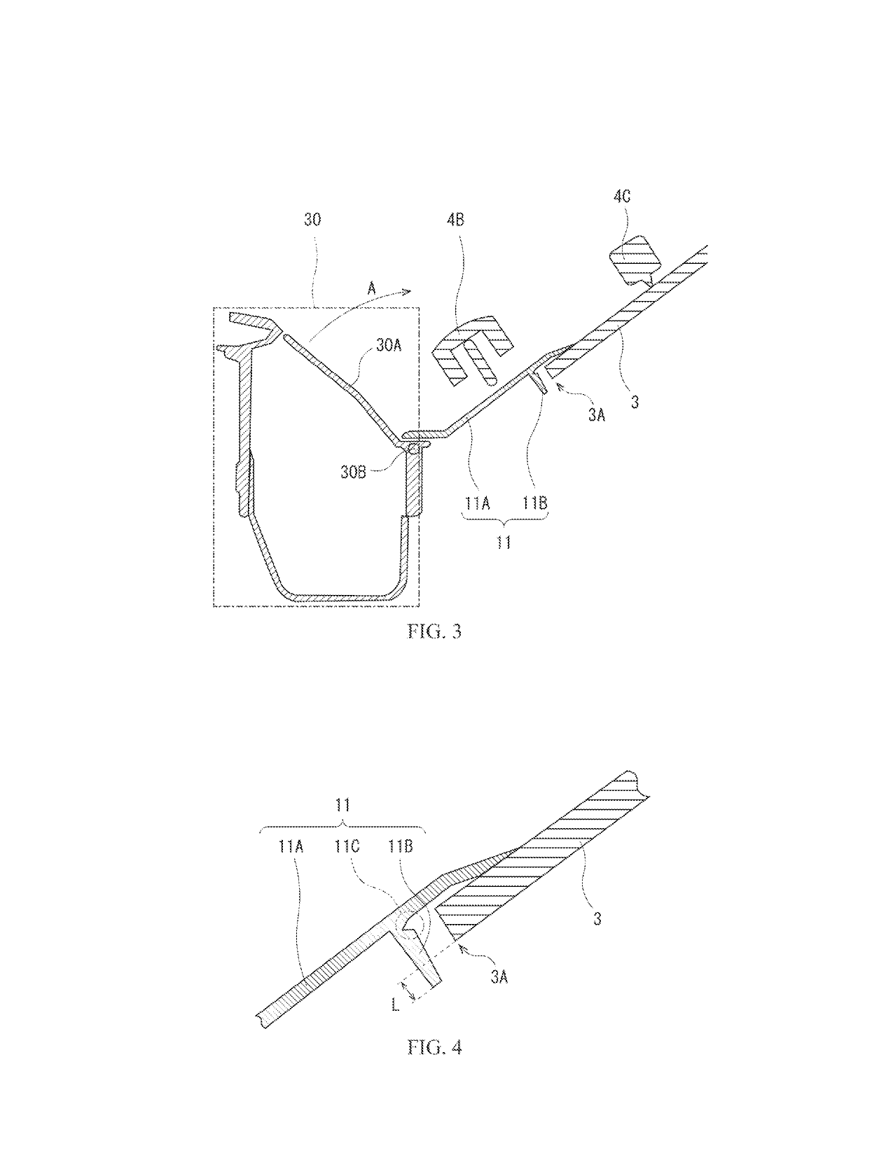

FIG. 3 illustrates an example of a schematic sectional configuration of one of the wiper devices 4, the cowl top panel 11, and the airbag device 30 as viewed in an arrowed direction along line III-III in FIG. 2B.

The cowl top panel 11 includes a panel 11A and a rib 11B. The panel 11A may be a body of the cowl top panel 11. The panel 11A is disposed to cover a lower end part 3A of the windshield 3 from the front surface of the windshield 3. The rib 11B is provided on a rear surface (a lower surface in FIG. 3) of the panel 11A and is provided in a region of the rear surface different from a region opposed to the windshield 3. As illustrated in FIGS. 2A and 2B, the rib 11B may extend along the entire width of the cowl top panel 11 in the width direction of the vehicle 1 on the rear surface of the panel 11A. The rib 11B may be provided to ensure the strength of the cowl top panel 11.

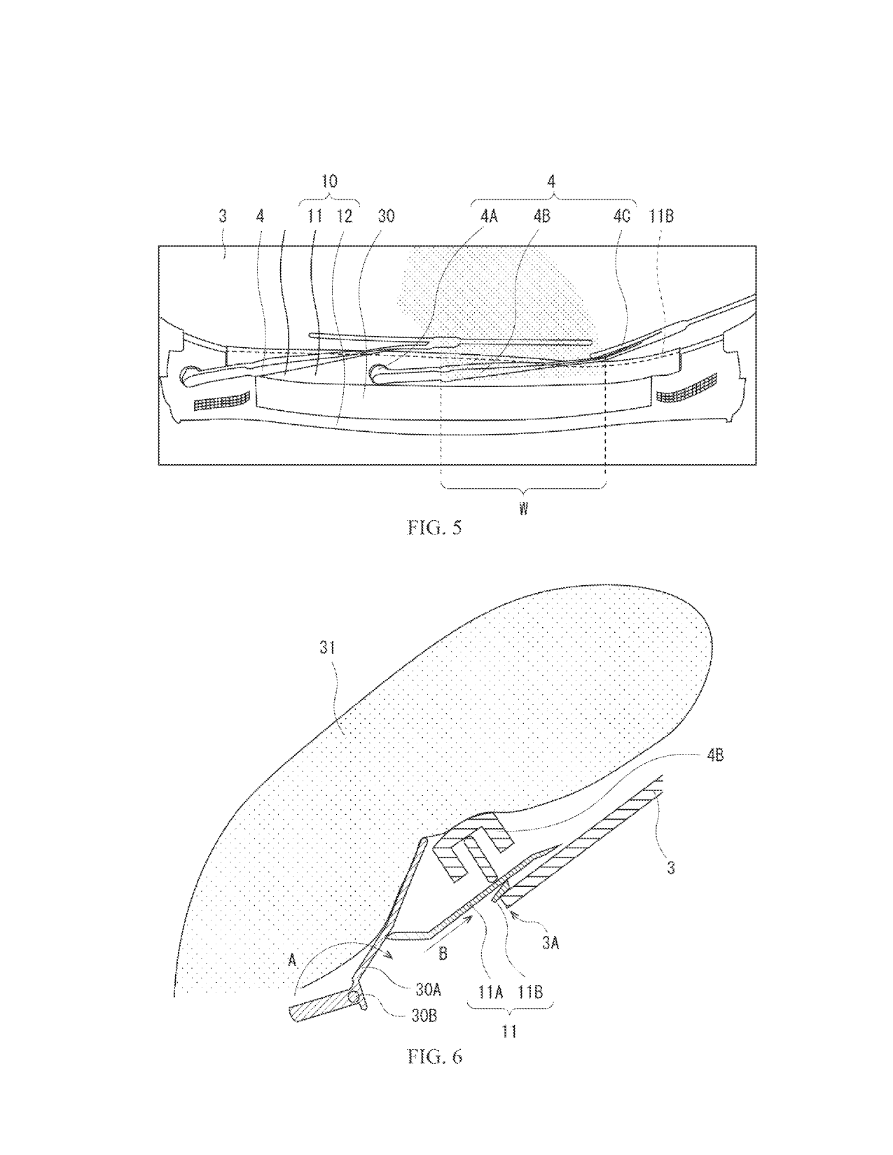

FIG. 4 illustrates a configuration example of the rib 11B. A distal end of the rib 11B extends beyond a rear surface of the windshield 3 in a normal direction of the windshield 3 by a length L. Further, a notch 11C may be provided at a coupling part of the rib 11B to the panel 11A. In this example, the notch 11C may be provided on a side (a right side in FIG. 4) of the rib 11B where the windshield 3 is disposed. For example, as illustrated in FIG. 5, the notch 11C may be provided in a part W of the rib 11B corresponding to a movable range (shaded part) of, for example, one of the wiper arms 4B provided at or around a middle part in the width direction of the vehicle 1. The wiper arm 4B may be provided on a side of a front surface of the panel 11A. Note that, this example is a non-limiting example. In some embodiments, the notch 11C may be provided along the entire width of the rib 11B in the width direction of the vehicle 1.

The airbag device 30 may include a cover 30A as illustrated in FIG. 3. The cover 30A may be configured to be rotatable about a shaft 30B. In the airbag device 30, for example, if the vehicle 1 comes into contact with a pedestrian, an unillustrated inflator may send gas to the airbag 31 (unillustrated in FIG. 3) housed in the airbag device 30. As a result, the airbag 31 may be inflated, pushing up the cover 30A in an A-direction, and may be deployed to the outside of the vehicle 1.

In one embodiment, the front hood 2 may serve as a "front hood". In one embodiment, the windshield 3 may serve as a "windshield". In one embodiment, the cowl top panel 11 may serve as a "cowl top panel". In one embodiment, the panel 11A may serve as a "panel". In one embodiment, the rib 11B may serve as a "rib". In one embodiment, the notch 11C may serve as a "notch". In one embodiment, the airbag device 30 may serve as an "airbag device". In one embodiment, the wiper arm 4B may serve as a "wiper arm". In one embodiment, the rear surface of the panel 11A may serve as a "first surface". In one embodiment, the front surface of the panel 11A may serve as a "second surface".

### <Operation and Workings>

Next, an operation and workings of the vehicle 1 according to the present example embodiment will be described.

### <Overview of Overall Operation>

First, an operation of the vehicle 1 will be described with reference to FIG. 1. The airbag device 30 may deploy the airbag 31 to the outside of the vehicle 1 in order to protect a pedestrian if the vehicle 1 comes into contact with the pedestrian. If the vehicle 1 comes into contact with the pedestrian, the airbag 31 may push up the cover 30A of the airbag device 30 and be deployed to the outside of the vehicle 1. When the cover 30A is pushed up, the cover 30A may push the cowl top panel 11 toward the windshield 3, and the cowl top panel 11 may move toward the windshield 3. The rib 11B provided on the rear surface of the cowl top panel 11 may come into contact with the lower end part 3A of the windshield 3. As a result, the rib 11B breaks at a position where the notch 11C is provided.

### <Details of Operation>

FIG. 6 illustrates an operation example of the cowl top panel 11 when the airbag 31 is deployed.

If the vehicle 1 comes into contact with a pedestrian, the unillustrated inflator may send gas to the airbag 31 housed in the airbag device 30. As a result, the airbag 31 may be inflated, pushing up the cover 30A in the A-direction, and may be deployed to the outside of the vehicle 1. The deployed airbag 31 may push, for example, the wiper arm 4B provided at or around the middle in the width direction of the vehicle 1 toward the cowl top panel 11.

When being pushed up, the cover 30A may rotate about the shaft 30B. When rotating in this manner, the cover 30A may come into contact with an end part of the cowl top panel 11 and push the cowl top panel 11 toward the windshield 3. As a result, the cowl top panel 11 may move in a B-direction. The rib 11B provided on the rear surface of the panel 11A of the cowl top panel 11 may come into contact with the lower end part 3A of the windshield 3. While a force in the B-direction is applied to the rib 11B, the cowl top panel 11 may be pushed against the windshield 3 by the airbag 31 and the wiper arm 4B. Consequently, the rib 11B breaks at a position where the notch 11C is provided as illustrated in FIG. 6. Thereafter, the cowl top panel 11 may further move in the B-direction.

As described above, in the vehicle 1, the rib 11B of the cowl top panel 11 breaks. This helps to prevent the windshield 3 from being damaged unlike in a case of a reference example described below.

### <Reference Example>

Next, a vehicle including a cowl top panel 101 according to the reference example will be described. The cowl top panel 101 includes a rib 101B that does not have the notch 11C.

FIG. 7 illustrates an operation example of the cowl top panel 101 according to the reference example when the airbag 31 is deployed.

When the airbag 31 is deployed, the cover 30A pushes the cowl top panel 101 toward the windshield 3. This causes the cowl top panel 101 to move in the B-direction. Thereafter, the rib 101B of the cowl top panel 101 comes into contact with the lower end part 3A of the windshield 3. While a force in the B-direction is applied to the rib 101B, the cowl top panel 101 may be pushed against the windshield 3 by the airbag 31 and the wiper arm 4B. In this example, the rib 101B is not provided with the notch 11C. Consequently, in this example, the rib 101B does not break, and the cowl top panel 101 slides over the windshield 3.

As illustrated in FIG. 7, because the cowl top panel 101 slides over the windshield 3 without the rib 101B being broken, the distal end of the rib 101B comes into contact with the front surface of the windshield 3. The cowl top panel 101 is pressed against the windshield 3 by the airbag 31 and the wiper arm 4B. As a result, the windshield 3 may possibly be damaged by the distal end of the rib 101B.

In contrast, in the cowl top panel 11 according to the present example embodiment, the rib 11B has the notch 11C. Thus, the rib 11B breaks when the rib 11B comes into contact with the lower end part 3A of the windshield 3. This helps to prevent the distal end of the rib 11B from damaging the windshield 3.

As described above, the cowl top panel 11 includes the panel 11A and the rib 11B. The panel 11A is provided between the front hood 2 and the windshield 3, which are at the front part of the vehicle 1. The panel 11A extends in the width direction of the vehicle 1 and is provided to cover the lower end part 3A of the windshield 3. The rib 11B is provided on the first surface of the panel 11A. The first surface of the panel 11A is a surface on the side where the windshield 3 is provided. The rib 11B is provided in a region of the first surface different from a region opposed to the windshield 3. The rib 11B protrudes from the first surface of the panel 11A and extends in the width direction of the vehicle 1. The distal end of the rib 11B extends beyond the rear surface of the windshield 3 in the normal direction of the windshield 3. The rib 11B has the notch 11C and is configured to, when the airbag 31 is deployed from the airbag device 30 provided between the panel 11A and the front hood 2 to the outside of the vehicle 1 and the panel 11A moves toward the windshield 3, break at a position where the notch 11C is provided by coming into contact with the lower end part 3A of the windshield 3. As described above, in the cowl top panel 11, the rib 11B comes into contact with the lower end part 3A of the windshield 3 as illustrated in FIG. 6. This causes the rib 11B to break at a position where the notch 11C is provided. Thus, the distal end of the rib 11B does not come into contact with the front surface of the windshield 3 as in the reference example illustrated in FIG. 7, which may possibly damage the windshield 3. This configuration helps to prevent the cowl top panel 11 from damaging the windshield 3.

In some embodiments, in the cowl top panel 11, the notch 11C may be provided at the coupling part of the rib 11B to the panel 11A. This configuration makes it possible for the rib 11B of the cowl top panel 11 to easily break at its base when the cowl top panel 11 moves in the B-direction, causing the rib 11B to come into contact with the lower end part 3A of the windshield 3 as illustrated in FIG. 6. As a result, the configuration helps to prevent the cowl top panel 11 from damaging the windshield 3.

In some embodiments, in the cowl top panel 11, the notch 11C may be provided in at least a part of the rib 11B corresponding to the movable range of, for example, the wiper arm 4B provided at or around the middle in the width direction of the vehicle 1. The wiper arm 4B may be provided on a side of a second surface of the panel 11A. The second surface of the panel 11A is a surface opposite to the first surface of the panel 11A. Providing the notch 11C as described above makes it possible to efficiently break the rib 11B in the cowl top panel 11. For example, when the airbag 31 is deployed, the wiper arm 4B can rotate about the corresponding shaft unit 4A. Thus, the wiper arm 4B may be in any position in the movable range illustrated in FIG. 5. While a force in the B-direction is applied to the rib 11B, the cowl top panel 11 may be pressed against the windshield 3 by the airbag 31 and the wiper arm 4B. This makes it possible for the rib 11B to easily break at a position where the wiper arm 4B is present. As a result, the configuration helps to prevent the cowl top panel 11 from damaging the windshield 3.

### <Example Effects>

As described above, the present example embodiment includes the panel and the rib. The panel is provided between the front hood and the windshield, which are at the front part of the vehicle. The panel extends in the width direction of the vehicle and is provided to cover the lower end part of the windshield. The rib is provided on the first surface of the panel. The first surface of the panel is the surface on the side where the windshield is provided. The rib is provided in the region of the first surface different from the region opposed to the windshield. The rib protrudes from the first surface of the panel and extends in the width direction of the vehicle. The distal end of the rib extends beyond the rear surface of the windshield in the normal direction of the windshield. The rib has the notch and is configured to, when the airbag is deployed from the airbag device provided between the panel and the front hood to the outside of the vehicle and the panel moves toward the windshield, break at a position where the notch is provided by coming into contact with the lower end part of the windshield. This helps to prevent damaging the windshield.

In some embodiments, the notch may be provided at the coupling part of the rib to the panel. This helps to prevent damaging the windshield.

In some embodiments, the notch may be provided in at least a part of the rib corresponding to the movable range of, for example, the wiper arm provided at or around the middle in the width direction of the vehicle. The wiper arm may be provided on the side of the second surface of the panel. The second surface of the panel may be the surface opposite to the first surface of the panel. Providing the notch helps to prevent damaging the windshield.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

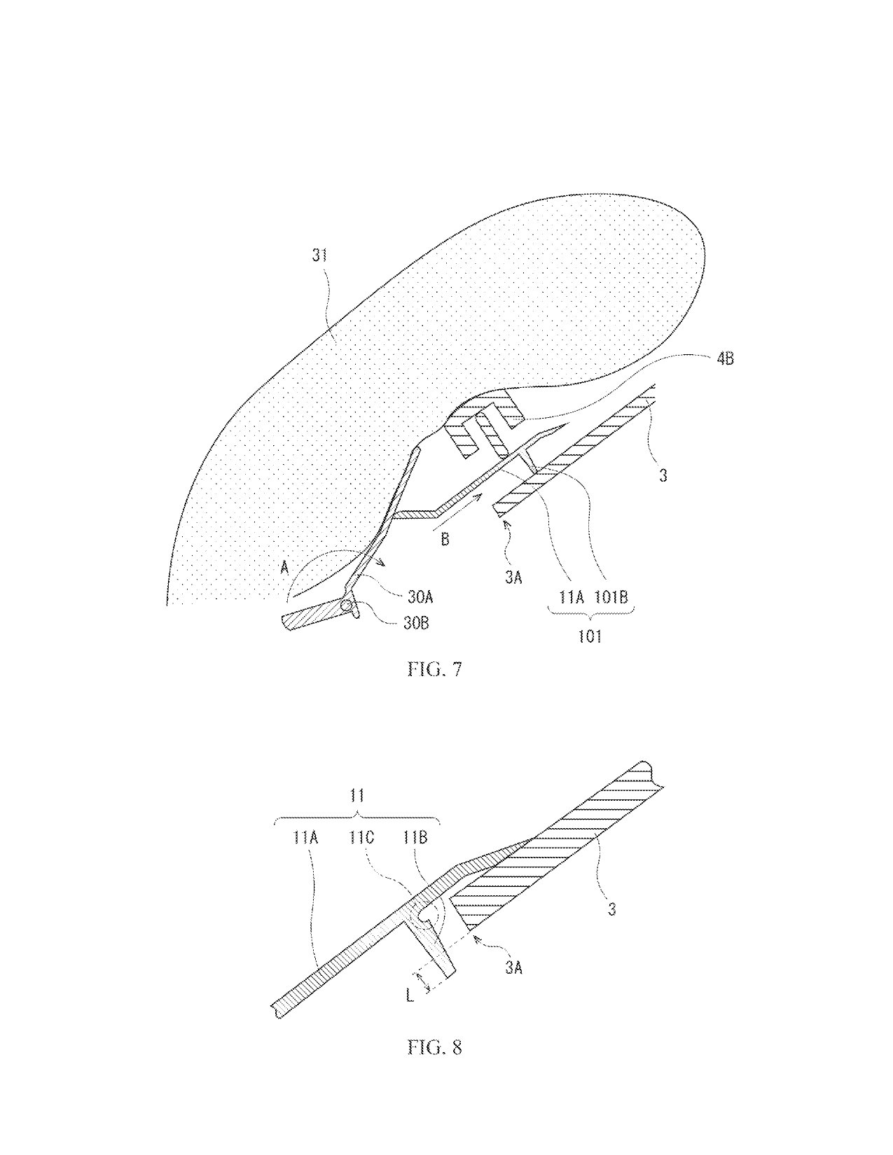

Although the sectional shape of the notch 11C is a triangular shape in the above-described example embodiment as illustrated in FIG. 4, this example is a non-limiting example, and the sectional shape of the notch 11C may be any shape. In some embodiments, the sectional shape of the notch 11C may be a semicircular shape, for example, as illustrated in FIG. 8.

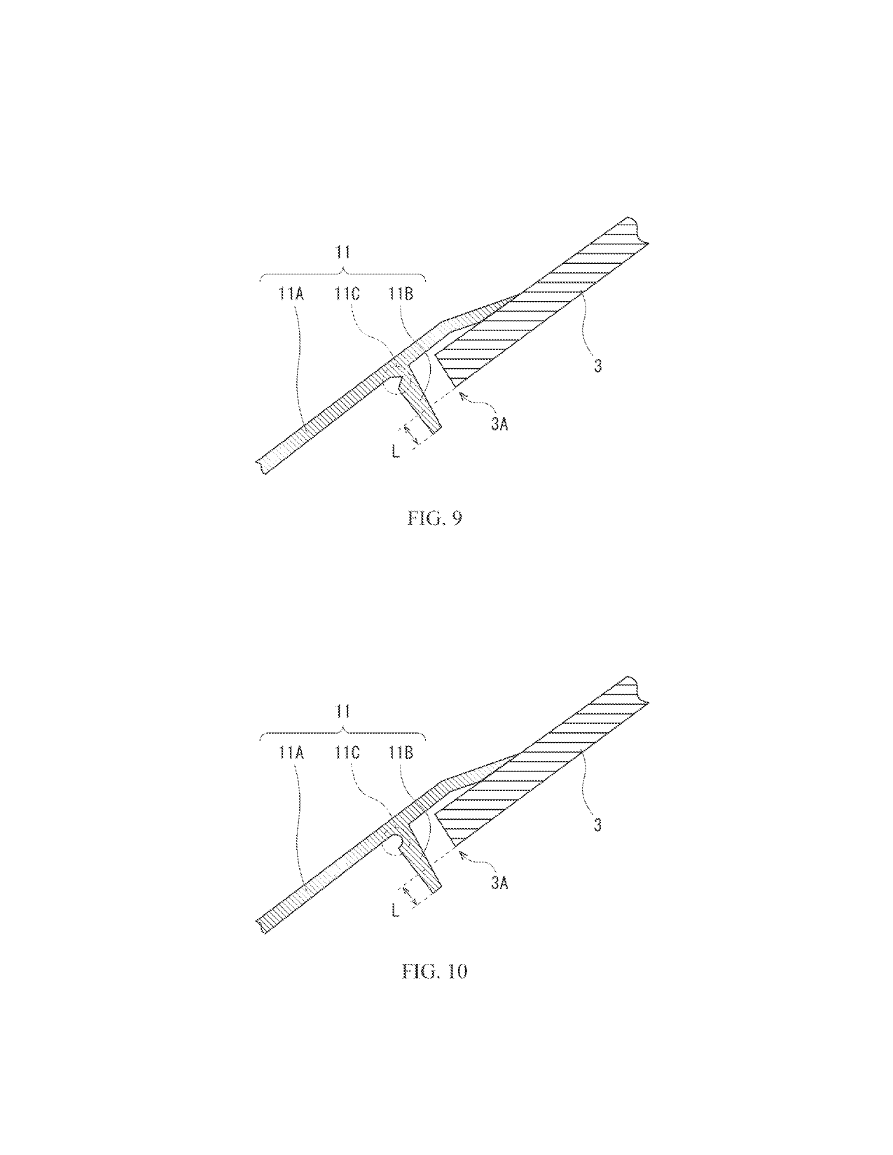

Although the notch 11C is provided on the side of the rib 11B where the windshield 3 is disposed in the above-described example embodiment as illustrated in FIG. 4 (for example, although the notch 11C is provided on the right side of the rib 11B in FIG. 4), this example is a non-limiting example. In some embodiments, as illustrated in FIGS. 9 and 10, the notch 11C may be provided on the side of the rib 11B opposite to the side where the windshield 3 is disposed. FIG. 9 illustrates an example in which the sectional shape of the notch 11C is a triangular shape, and FIG. 10 illustrates an example in which the sectional shape of the notch 11C is a semicircular shape.

The example effects described herein are mere examples, and example effects of the disclosure are therefore not limited to those described herein, and other example effects may be achieved.

Furthermore, the disclosure may encompass at least the following embodiments.

1. A cowl top panel to be applied to a vehicle, the cowl top panel including:

a panel provided between a front hood and a windshield that are at a front part of the vehicle, the panel extending in a width direction of the vehicle and being configured to cover a lower end part of the windshield; and

a rib provided on a first surface of the panel, the first surface of the panel being a surface on a side where the windshield is provided, the rib being provided in a region of the first surface different from a region opposed to the windshield, the rib protruding from the first surface of the panel and extending in the width direction of the vehicle, in which

the rib includes a distal end extending beyond a rear surface of the windshield in a normal direction of the windshield, and

the rib has a notch and is configured to, when an airbag is deployed from an airbag device provided between the panel and the front hood to an outside of the vehicle and the panel moves toward the windshield, break at a position where the notch is provided by coming into contact with the lower end part of the windshield.

2. The cowl top panel according to (1), in which the notch is provided at a coupling part of the rib to the panel.

3. The cowl top panel according to (1) or (2), in which the notch is provided in at least a part of the rib corresponding to a movable range of a wiper arm, the wiper arm being provided on a side of a second surface of the panel, the second surface of the panel being a surface opposite to the first surface of the panel.

4. A vehicle including:

a front hood provided at a front part of the vehicle;

a windshield provided at the front part of the vehicle;

a cowl top panel provided between the windshield and the front hood; and

an airbag device provided between the cowl top panel and the front hood and configured to deploy an airbag to an outside of the vehicle, in which

the cowl top panel includes:

a panel extending in a width direction of the vehicle and being configured to cover a lower end part of the windshield; and

a rib provided on a first surface of the panel, the first surface of the panel being a surface on a side where the windshield is provided, the rib being provided in a region of the first surface different from a region opposed to the windshield, the rib protruding from the first surface of the panel and extending in the width direction of the vehicle,

the rib includes a distal end extending beyond a rear surface of the windshield in a normal direction of the windshield, and

the rib has a notch and is configured to, when the airbag is deployed from the airbag device and the panel moves toward the windshield, break at a position where the notch is provided by coming into contact with the lower end part of the windshield.

A cowl top panel and a vehicle according to at least one example embodiment of the disclosure each make it possible to prevent damaging a windshield when an airbag is deployed.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive.

As used in this specification and the appended claims, the singular forms "a," "an," and "the" include, especially in the context of the claims, are to be construed to cover both the singular and the plural, unless otherwise indicated herein or clearly contradicted by context.

Throughout this specification and the appended claims, unless the context requires otherwise, the terms "comprise", "include", "have", and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The terms "substantially", "approximately", "about", and their variants having the similar meanings thereto are defined as being largely but not necessarily wholly what is specified as understood by one of ordinary skill in the art.

The term "disposed on/ provided on/ formed on" and its variants having the similar meaning thereto as used herein refer to elements disposed directly in contact with each other or indirectly by having intervening structures therebetween.

1. A cowl top panel configured to be applied to a vehicle, the cowl top panel comprising:
a panel provided between a front hood and a windshield that are at a front part of the vehicle, the panel extending in a width direction of the vehicle and being configured to cover a lower end part of the windshield; and
a rib provided on a first surface of the panel, the first surface of the panel being a surface on a side where the windshield is provided, the rib being provided in a region of the first surface different from a region opposed to the windshield, the rib protruding from the first surface of the panel and extending in the width direction of the vehicle, wherein
the rib comprises a distal end extending beyond a rear surface of the windshield in a normal direction of the windshield, and
the rib has a notch and is configured to, when an airbag is deployed from an airbag device provided between the panel and the front hood to an outside of the vehicle and the panel moves toward the windshield, break at a position where the notch is provided by coming into contact with the lower end part of the windshield.

2. The cowl top panel according to claim 1, wherein the notch is provided at a coupling part of the rib to the panel.

3. The cowl top panel according to claim 1, wherein the notch is provided in at least a part of the rib corresponding to a movable range of a wiper arm, the wiper arm being provided on a side of a second surface of the panel, the second surface of the panel being a surface opposite to the first surface of the panel.

4. A vehicle comprising:
a front hood provided at a front part of the vehicle;
a windshield provided at the front part of the vehicle;
a cowl top panel provided between the windshield and the front hood; and
an airbag device provided between the cowl top panel and the front hood and configured to deploy an airbag to an outside of the vehicle, wherein
the cowl top panel comprises:
a panel extending in a width direction of the vehicle and being configured to cover a lower end part of the windshield; and
a rib provided on a first surface of the panel, the first surface of the panel being a surface on a side where the windshield is provided, the rib being provided in a region of the first surface different from a region opposed to the windshield, the rib protruding from the first surface of the panel and extending in the width direction of the vehicle,
the rib comprises a distal end extending beyond a rear surface of the windshield in a normal direction of the windshield, and
the rib has a notch and is configured to, when the airbag is deployed from the airbag device and the panel moves toward the windshield, break at a position where the notch is provided by coming into contact with the lower end part of the windshield.
